(19) United States
(12) Patent Application Publication
(10) Pub. No.: US 2011/0105135 A1
(43) Pub. Date: May 5, 2011

(54) INTERFERENCE COORDINATION IN HETEROGENEOUS NETWORKS USING WIRELESS TERMINALS AS RELAYS

(75) Inventors: Sandeep H. Krishnamurthy, Arlington Heights, IL (US); Colin D. Frank, Park Ridge, IL (US); Robert T. Love, Barrington, IL (US)

(73) Assignee: MOTOROLA-MOBILITY, INC., Libertyville, IL (US)

(21) Appl. No.: 12/916,871

(22) Filed: Nov. 1, 2010

Related U.S. Application Data
(60) Provisional application No. 61/257,817, filed on Nov. 3, 2009.

(51) Int. Cl. H04W 72/04

(52) U.S. Cl. 455/450

(57) ABSTRACT

A method in a wireless communication device and a wireless base station related to spectral efficiency optimization via interference control and mitigation in heterogeneous networks including macro-cells and home-base stations or femto-cells, wherein a mobile station provides a path for coordinating resource utilization between two base stations to facilitate interference coordination and/or mitigation.

### CROSS REFERENCE TO RELATED APPLICATIONS

The present application is a non-provisional application of U.S. provisional Application No. 61/257,817 filed on 3 Nov. 2009, the contents of which are incorporated by reference herein and from which benefits are claimed under 35 U.S.C.119.

### FIELD OF THE DISCLOSURE

The present disclosure relates to wireless communications and, more specifically, to spectral efficiency optimization via interference control and mitigation in heterogeneous networks comprising macro-cells and home-base stations or femto-cells.

### BACKGROUND

Some wireless communication networks are completely proprietary, while others are subject to one or more standards to allow various vendors to manufacture equipment for a common system. One standards-based network is the Universal Mobile Telecommunications System (UMTS), which is standardized by the Third Generation Partnership Project (3GPP). 3GPP is a collaborative effort among groups of telecommunications associations to make a globally applicable third generation (3G) mobile phone system specification within the scope of the International Mobile Telecommunications-2000 project of the International Telecommunication Union (ITU). The UMTS standard has evolved beyond 3G in what is typically referred to as UMTS Long Term Evolution (LTE) or Evolved UMTS Terrestrial Radio Access (E-UTRA).

According to Release 8 of the E-UTRA or LTE standard or specification, downlink communications from a base station (referred to as an “enhanced Node-B” or simply “eNB”) to a wireless communication device (referred to as “user equipment” or “UE”) utilize orthogonal frequency division multiplexing (OFDM). In OFDM, orthogonal subcarriers are modulated with a digital stream, which may include data, control information, or other information, so as to form a set of OFDM symbols. The subcarriers may be contiguous or non-contiguous and the downlink data modulation may be performed using quadrature phase shift-keying (QPSK), 16-ary quadrature amplitude modulation (16QAM), or 64QAM. The OFDM symbols are configured into a downlink sub frame for transmission from the base station. Each OFDM symbol has a temporal duration and is associated with a cyclic prefix (CP). A cyclic prefix is essentially a guard period between successive OFDM symbols in a sub frame. According to the E-UTRA specification, a normal cyclic prefix is about five (5) microseconds and an extended cyclic prefix is about 16.67 microseconds. The data from the serving base station is transmitted on physical downlink shared channel (PDSCH) and the control information is signaled on physical downlink control channel (PDCCH).

In contrast to the downlink, uplink communications from the UE to the eNB utilize single-carrier frequency division multiple access (SC-FDMA) according to the E-UTRA standard. In SC-FDMA, block transmission of QAM data symbols is performed by first discrete Fourier transform (DFT)-spreading (or precoding) followed by subcarrier mapping to a conventional OFDM modulator. The use of DFT precoding allows a moderate cubic metric/peak-to-average power ratio (PAPR) leading to reduced cost, size and power consumption of the UE power amplifier. In accordance with SC-FDMA, each subcarrier used for uplink transmission includes information for all the transmitted modulated signals, with the input data stream being spread over them. The data transmission in the uplink is controlled by the eNB, involving transmission of scheduling grants (and scheduling information) sent via downlink control channels. Scheduling grants for uplink transmissions are provided by the eNB on the downlink and include, among other things, a resource allocation (e.g., a resource block size per one millisecond (ms) interval) and an identification of the modulation to be used for the uplink transmissions. With the addition of higher-order modulation and adaptive modulation and coding (AMC), large spectral efficiency is possible by scheduling users with favorable channel conditions. The UE transmits data on the physical uplink shared channel (PUSCH). The physical control information is transmitted by the UE on the physical uplink control channel (PUCCH).

E-UTRA systems also facilitate the use of multiple input and multiple output (MIMO) antenna systems on the downlink to increase capacity. As is known, MIMO antenna systems are employed at the eNB through use of multiple transmit antennas and at the UE through use of multiple receive antennas. A UE may rely on a pilot or reference signal (RS) sent from the eNB for channel estimation, subsequent data demodulation, and link quality measurement for reporting. The link quality measurements for feedback may include such spatial parameters as rank indicator, or the number of data streams sent on the same resources; precoding matrix index (PMI); and coding parameters, such as a modulation and coding scheme (MCS) or a channel quality indicator (CQI). For example, if a UE determines that the link can support a rank greater than one, it may report multiple CQI values (e.g., two CQI values when rank=2). Further, the link quality measurements may be reported on a periodic or aperiodic basis, as instructed by an eNB, in one of the supported feedback modes. The reports may include wideband or subband frequency selective information of the parameters. The eNB may use the rank information, the CQI, and other parameters, such as uplink quality information, to serve the UE on the uplink and downlink channels.

A home-basestation or femto-cell or pico-eNB or relay node (RN) is referred to as hetero-eNB (HeNB) or a hetero-cell or hetero base station in the sequel. A HeNB can either belong to a closed subscriber group (CSG) or can be an open-access cell. A CSG is set of one or more cells that allow access only to a certain group of subscribers. HeNB deployments where at least a part of the deployed bandwidth (BW) is shared with macro-cells are considered to be high-risk scenarios from an interference point-of-view. When UEs connected to a macro-cell roam close to a HeNB, the uplink of the HeNB can be severely interfered with particularly when the HeNB is far away (for example>400 m) from the macro-cell, thereby, degrading the quality of service of UEs connected to the HeNB. Currently, the existing Rel-8 UE measurement framework can be made use of to identify the situation when this interference might occur and the network can handover the UE to an inter-frequency carrier which is not shared between macro-cells and HeNBs to mitigate this problem. However, there might not be any such carriers available in certain networks to handover the UE to. Further, as the penetration of HeNBs increases, being able to efficiently operate HeNBs on the entire available spectrum might be desirable from a cost perspective. Even when a UE roams close to an allowed HeNB, it is possible that it experiences significant interference from the HeNB. Several other scenarios are likely too including the case of a UE connected one HeNB experiencing interference from an adjacent HeNB or a macro cell. The following types of interference scenarios have been identified.

HeNB (aggressor)→MeNB (victim) downlink (DL)

HUE (aggressor)→MeNB (victim) uplink (UL)

MUE (aggressor)→HeNB (victim) UL

MeNB (aggressor)→HeNB (victim) DL

HeNB (aggressor)→HeNB (victim) on DL

HeNB (aggressor)→HeNB (victim) on UL.

In this disclosure, we discuss HeNB uplink (UL) interference and downlink (DL) interference problems in further detail and propose a method that can enable a more effective co-channel/shared channel deployment of HeNBs in LTE Rel-9 systems and beyond.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the one or more embodiments of the present invention.

FIG. 1 is a schematic diagram with macro-cell and a home-base station in the macro-cell's coverage area.

FIG. 2 shows a schematic diagram with macro-cell and a home-base station in the macro-cell's coverage area, in accordance with the present invention.

FIG. 3 shows a schematic diagram of a X2 interface architecture proposed in R4-093203, in accordance with the present invention.

FIG. 4 shows a schematic diagram of a wireless terminal in the proximity of heterogeneous base stations being used by the network for relaying coordination information in accordance with the present invention.

FIG. 5 shows a flow chart of a serving eNB sending coordination information to a wireless terminal and configuring it to transmit the information on the uplink.

FIG. 5 shows a flow chart of a wireless terminal receiving coordination information from the serving eNB and the wireless terminal then transmitting this information on its uplink.

### DETAILED DESCRIPTION

There are disclosed methods of a wireless communication device and a wireless base station. The device is served by a serving base station and receives from a neighbor base station a downlink transmission including a broadcast signal.

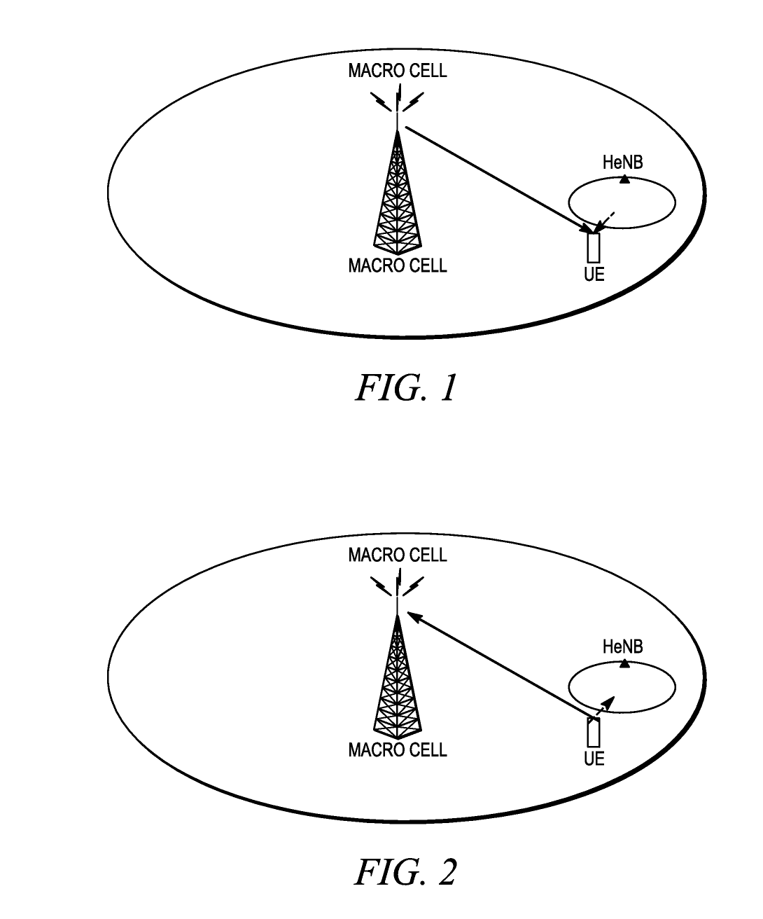

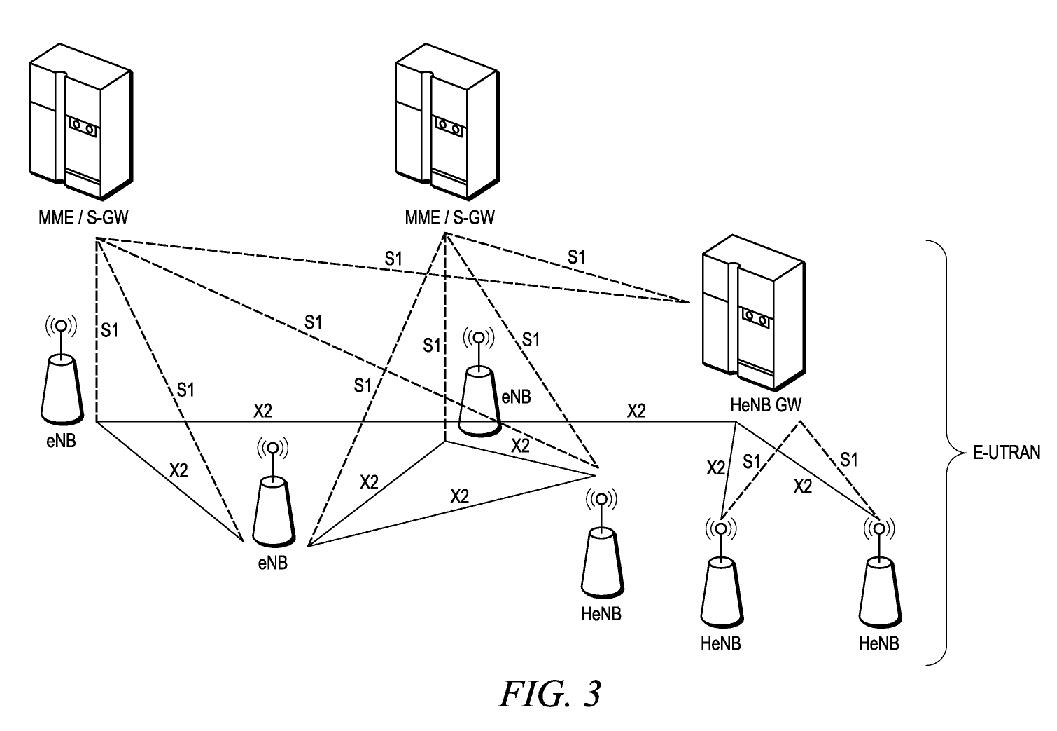

In a heterogeneous network comprising macro cells and HeNBs cells that have overlapping bandwidth (BW) deployments, certain interference problems can arise. One such interference problem is depicted in FIG. 1, where the uplink (UL) transmission from a UE connected to a macro-eNB (MeNB) that is close to (i.e., within signal range of a HeNB) severely interferes with the UL of a UE connected to the HeNB. This case has been identified as interference scenario 3 in 3GPP TR 25.967 “Home Node B Radio Frequency (RF) Requirements (FDD) (Release 9)” in Universal Terrestrial Radio Access (UTRA) network.

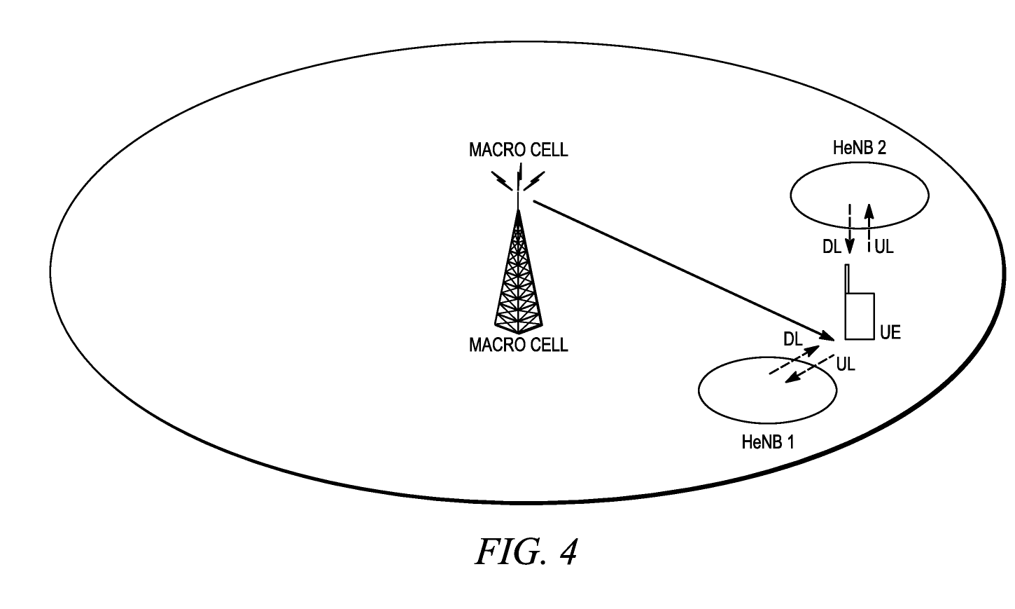

A summary of coordination techniques proposed in 3GPP RAN4 working group to date is as follows. R4-093203 proposes that MeNBs “reserve” a certain number of RBs for its DL and transmit a DL high interference indicator (DL-HII) message over X2 to HeNBs in the “protection area”. R4-092872 proposes that UEs connected to HeNBs reports per-subband signal to interference ratio estimated on a per-subband basis to request/grant/deny resources to other UEs. These requests/grants are made on X2. R4-093196 proposes that a HeNB “detect” PRB allocation of MeNB by over-the-air (OTA) measurements assuming scheduling persistence for determining the MeNB resource usage. But, scheduler allocation strategy is purely an implementation issue and any sort of RB usage persistence cannot be assumed. This necessitates exchange of coordination information over X2. R4-093092 proposes a soft-frequency reuse technique, where the available resource blocks are partitioned for scheduling cell-center and cell-edge users on orthogonal resources. A dynamic partitioning followed by exchange of this information between MeNB and HeNB seems desirable. In particular, among the techniques discussed, it appears that the exchange of coordination information over X2 is essential. R4-093203 proposes the architecture shown in FIG. 3 for X2 for HeNBs.

Implementation of X2 is expensive and is not preferred by most operators. RAN2 has almost always assumed that HeNBs will not have X2 as the deployments will be uncoordinated. The current working assumption across multiple working groups is that X2 will not be implemented in Rel-9 and Rel-10 may be the earliest when X2 will be considered for HeNBs. So, alternative solutions that can enable coordination without having to implement X2 would seem attractive for enabling pre-Rel-10 HeNB deployments. A UE connected to a MeNB can be effectively used towards this end. We discuss this idea further in this disclosure. A network operator would find it desirable for the overlay macro-cellular network not to experience any throughput degradation due to the deployment of HeNBs. This can be accomplished by, a mechanism which would allow for a MeNB to “reserve” a certain set of time-frequency resources for its use with a guarantee that no HeNB would transmit on those resources when there is a possibility that it would interfere with a UE being served by the macro-cell (i.e., the victim UE). Currently, inter-cell interference coordination (ICIC) function of signaling over X2 exists in Rel-8 where a cell tells another cell to modify scheduling/resource allocation of a UE that is interfering with its own allocation. UE measurements may be made to enable such signaling.

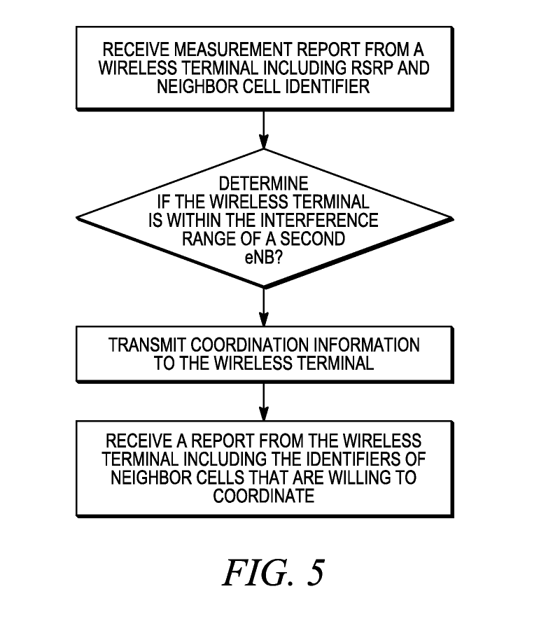

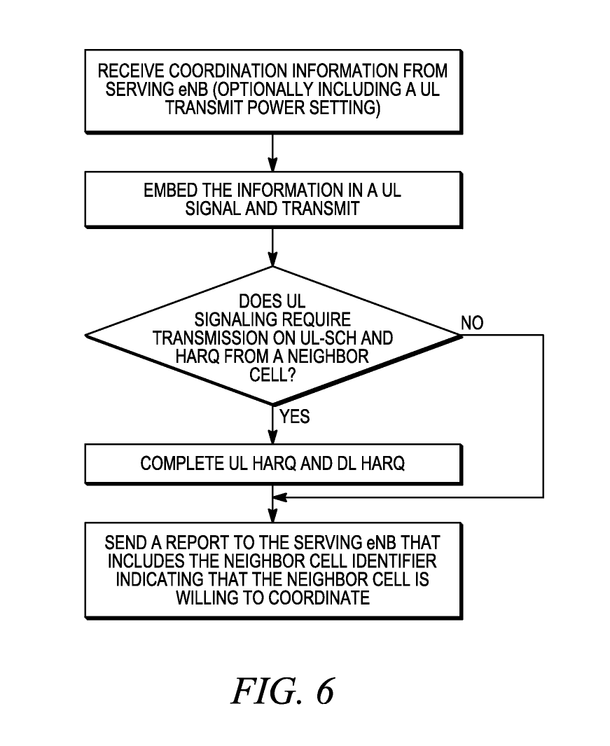

When a UE connected to a MeNB roams close to a HeNB, it is within the interference region of that HeNB. The event that one or more HeNB(s) are the dominant interferers to the UE DL can be deduced by the network from RSRP reports. In such a scenario, the serving eNB may transmit coordination information pertaining to a time-frequency resource partition indicating the set of resources it chooses to use (i.e., the set of resources the HeNBs are forbidden from using) to the UE within the interference range of HeNBs as shown in FIG. 4. Alternately, the set of resources on which the HeNBs are allowed to transmit on can be sent to the UE instead. This information can be sent over a RRC configuration message. Upon receipt of this information, the UE relays this message to HeNBs through UL signaling. The transmit power to be used by the UE can be determined by the serving eNB (for example, based on the UE reports of RSRP of the HeNBs) or alternately, it can be determined by the UE itself so that a suitable power level is used to ensure that the relayed information reaches all “relevant” HeNBs that can interfere with the UE. In this example, we considered the case of UE relaying DL-HII bits as per the resource block reservation approach in R4-093203. This principle can be generalized to cover other DL interference coordination techniques such as those proposed in R4-092872, R4-093196 or in R4-093092, and UL interference coordination methods.

The set of HeNBs “within range” of a macro-cell UE is also the set of HeNBs that pose a significant DL interference problem to the UE, the set of HeNBs whose UL can be potentially interfered with by the UE. The network can determine the HeNBs “within range” from RSRP reports tied to their respective PCID/GCID.

The following steps can be used to enable this coordination.
[Step 1] Serving cell (e.g. MeNB) determines that a UE is within interference range of HeNBs and that it needs coordination.
[Step 2] Serving cell identifies the set of resources in time/frequency (e.g. set of RBs, set of subframes within a radio frame, or a combination of the two—a set of RBs on a subset of the subframes, etc.) that it wishes that HeNBs exclude from their DL or UL allocations. It sends a RRC message to the UE indicating this set (also referred to as “coordination information” in the sequel) instructing the UE to use its UL for relaying this information to HeNBs within range.
[Step 3] The UE receives this information and then embeds it in a UL signal (details on this signal in the sequel). The serving cell may optionally set the transmit power (or the range of transmit power) the UE is required to use for its UL transmission or alternately, the UE may deduce the required power based on its RSRP measurements and certain assumptions on the HeNB DL transmit power. The idea is that all HeNBs within range of a UE
   pose an interference problem to the UE (DL), and/or
   may be interfered with on their UL due to the UEs UL transmission
   need to coordinate with the macro-cell and therefore need to reliably receive the coordination information.
[Step 4] The HeNBs receive the coordination signal and may send an ACK to the UE (depending on the UL message type used—details in the sequel).

Several options exist for relaying the coordination message. Two of them are described below.

The first embodiment is denoted as “UL Signaling Option 1” or as simply “Option 1” wherein physical random access channel (PRACH) is the signaling mechanism to HeNB. In this signaling option, PRACH is made use of either in open-loop mode or in closed-loop. The signaling can be executed by the following steps.
[Step 1] The UE first sends a PRACH (the serving cell can send the allowed PRACH preamble group index, RA-preamble index, and PRACH preamble configuration to be used similar to that done during a HO command) and expects a RACH-response. The coordination information can be embedded over one or more PRACH signal parameters (i.e., implicit signaling).
   PRACH offset in frequency domain
   ZC sequence root and cyclic shift.
One example how implicit signaling can be carried out is as follows. In Rel-8 FDD, for a 10 MHz DL/UL system, there are 45 frequency offsets possible for PRACH. There are 838 roots for the ZC sequence enabling each with a certain number of allowed cyclic shifts (say, 32 shifts per ZC sequence is configured), resulting in 838×32 combinations of roots and cyclic shifts. By implicitly encoding of coordination information in the PRACH frequency offset, ZC sequence index and cyclic shift, up to floor(log 2(45*838*32))=20 bits per PRACH (=6 PRBs) can be transmitted. Suppose that the time-frequency resources are partitioned as subbands of 3 PRBs in frequency, there are 17 subbands and one PRACH signal would be sufficient for signaling the set of “reserved” subbands (e.g. DL-HII as per R4-093203 is sent where one bit is signaled for every 3 PRBs). If there are more subbands or more bits of coordination information to be relayed, the relayed coordination signal could comprise of multiple PRACH signals.
In order to reduce the eNB PRACH processing complexity, a certain subset of all allowed frequency offsets, ZC roots and cyclic shifts may only be allowed. A proper selection of this subset would allow for some control over missed detection rate and false alarm rate.
[Step 2] One or more iterations of PRACH transmission may be used (similar to the Rel-8 initial RACH process where a re-transmission is initiated if a RACH-response is not received and the power is ramped up for the re-transmission) to improve reliability. The PRACH power should be set with the following considerations.
   The initial PRACH power should be set such that at least the closest HeNB receives the PRACH message reliably.
   The PRACH power on the first or remaining attempts should be high enough to reach to the furthest HeNB that poses an interference problem.
   The PRACH power on the last (or any) iteration should not be so high as to reach a HeNB which does not pose an interference problem.
[Step 3] Since the timing of the HeNBs within range is known to the UE after cell search, it knows where to expect the RACH-response from each HeNB. It might be desirable for the MeNB to signal the DL bandwidth of all HeNBs deployed in that band (and their carrier offsets if partial bandwidth HeNBs are deployed with overlapping bandwidth) so that the UE can decode PDCCH transmission from HeNBs that receive the coordination signal via PRACH. Further, the RACH-responses can be staggered in time (i.e., transmission on different subframes through pseudo-random subframe selection as a function of PCID/GCID) or transmitted on different time windows so that the UE does not receive RACH-response from more than one HeNB on the same subframe with a high probability. The RACH-responses from all of the HeNBs that receive the relayed signal can be decoded by the UE. The UE may optionally send a list of HeNBs that respond (and are a part of ICIC coordination) in a RRC response message to the serving eNB indicating the set of HeNB that responded and are willing to coordinate. For the inter-frequency case (e.g. 5 MHz HeNB offset by 2.5 MHz in a 10 MHz overlay macro network), DL/UL gaps may be necessary.
   Clearly, Step 1 and Step 2 are sufficient if the relay signaling were to be enabled in a open-loop mode (i.e., no RACH response). Step 3 allows for the macro network to maintain a list of HeNBs that are participating in ICIC-type coordination so that it has the option of disabling a certain aggressor HeNB which is posing a severe interference risk or moving it off to another frequency (for example, through S1 signaling).

The second embodiment is denoted as “UL Signaling Option 2” or simply as “Option 2” wherein uplink shared channel (UL-SCH) is the primary signaling mechanism to HeNB. In an alternate option, the signal flow is similar to that during a connection setup upon handover. The signaling can be executed by the following steps.
[Step 1] The UE first sends a PRACH and then receives RACH-response from at least one HeNB (the serving cell can send the allowed PRACH preamble group index, RA-preamble index, and PRACH preamble configuration to be used similar to that done during a HO command). Similar to that for the previous option, the RACH-response transmission occasions can be tied to the PCID/GCID of the HeNBs so that the UE receives at most one PDCCH with RA-RNTI (with high probability). The target HeNB sending the response sends an UL grant where the UE can transmit further information.
[Step 2] The UE embeds the coordination information in UL-SCH and transmits it on the allocated resources respectively to each HeNB that sends a grant. The relaying terminates with the successful completion of the HARQ process.
[Step 3] This step is similar to that in the previous option, where the UE reports back to the serving eNB the list of HeNBs that agreed to coordinate.

Option 1 is an “UL broadcast” scheme and is less complex on the UE side. But, unlike option 1, there is hard limit on the size of the coordination information that can be relayed (because of implicit signaling). This option may entail significant changes to a HeNB implementation relative to Rel-8 if the existing PRACH processing architecture cannot be scaled.

In Option 2, the UE would have to save the connection context with the serving eNB prior to initiating RACH or UL HARQ with the HeNB (similar to that during DL/UL gaps for inter-frequency measurements in Rel-8). But, the implementation complexity on the HeNB side would remain the same as that in LTE Rel-8.

Some aspects common to both options are summarized below.
1. The serving eNB may decide not schedule the UE involved in relaying for a certain duration of time. It may do so by configuring a DL/UL transmission gap explicitly.
2. The UE transmits a message on the uplink indicating that a MeNB is instructing the HeNBs not use schedule their own users on certain time/frequency resources. Two implementations can be envisaged as follows.
   In one implementation, any HeNB that can decode the message honors the request. Thus, the message might not be targeted to a particular HeNB. In this case, no ACK would be needed from the HeNB to the UE, although this can be made optional as in Step 3 of option 1. The resources could be released with a second uplink message from the UE, or alternatively, the request could have an expiration time so that even if no release message is transmitted (or if a message is transmitted and not received) the resource is still eventually released. With this implementation, the UE does not even need to know the identity of the interfering HeNBs. The power setting of the uplink transmission could be chosen so that only HeNBs close enough to interfere with the UE would be silenced on the reserved resources. Thus, the decision as to which HeNBs should be silenced is implicit in the UL power setting which can be made either by the UE autonomously (based on RSRP reports, etc.) or by the serving eNB (by RRC signaling). Furthermore, neither the UE nor the serving eNB needs to know the identities of the HeNBs being silenced as a single common message is used to silence multiple HeNBs rather than one message per HeNB.
   In an alternate implementation, one uplink message could be designed to carry a list of HeNBs to be silenced on the given time/frequency resource with a header containing the list of PCIDs/GCIDs as part of the coordination information. This alternative is more suitable with option 2.
      The approaches discussed here extend in a straightforward manner to MeNB-HeNB interference coordination on the UL and to HeNB-HeNB DL/UL interference coordination.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication terminal for assisting coordination between at least two base stations while the terminal is connected to a first base station, the method comprising:
receiving link coordination information from the first base station, the link coordination information relating to a set of a time-frequency resources that the first base station would like to either prohibit at least a second base station from using or allow at least a second base station to use for transmissions to and from its users;
embedding the link coordination information in an uplink (UL) signal; and
transmitting the UL signal having the embedded link coordination information.

2. The method of claim 1, wherein
transmitting the UL signal includes transmitting the uplink signal to the second base station,
the UL signal indicating to the second base station to not schedule transmissions on the time-frequency resources indicated in the link coordination information.

3. The method of claim 1, wherein
transmitting the UL signal includes transmitting the uplink signal to the second base station,
the UL signal indicating to the second base station that it may start to schedule transmission on the time-frequency resources indicated in the link coordination information.

4. The method of claim 1 wherein the UL signal is a message sent using PRACH, the method further comprising selecting a frequency offset, or a root of Zadoff-Chu sequence, or a cyclic shift applicable to the Zadoff-Chu sequence based on the link coordination information.

5. The method of claim 1 further comprising receiving information from the first base station pertaining to UL transmit power to be used when transmitting the UL signal.

6. The method of claim 1 further comprising measuring a reference signal received power (RSRP) of the second base station, and determining a power level to be used in the UL signal based on the measured RSRP.

7. The method of claim 1, wherein the time-frequency resources are a set a physical resource blocks.

8. The method of claim 1 further comprising receiving an ACK/NACK from the second base station in response to transmitting the UL signal.

9. The method of claim 1 wherein the UL signal is a message sent using UL-SCH to the second base station based at least in part on an uplink grant received from the second base station.

10. The method of claim 1 further comprising determining if the second base station is within interference range of the wireless terminal.

11. A method in a first wireless communication base station for coordinating with at least one other base station, the method comprising
transmitting link coordination information to a wireless communication terminal connected to the first wireless communication base station to be relayed to at least one other wireless communication base station,
the information relating to a set of time-frequency resources that the first wireless communication base station would like to allow or prohibit another wireless communication base station from using.

12. The method of claim 11 further comprising
receiving at the first wireless communication base station a measurement report from the wireless communication terminal corresponding to a second base station; and
transmitting the link coordination information to the wireless communication terminal based on determining that the wireless communication terminal is within an interference range of the second base station.

13. The method of claim 11 further including transmitting a power setting for the wireless communication terminal to use on its uplink signal that includes link coordination information.

14. A method in a first wireless communication base station for coordinating with at least a second wireless communication base station, the method comprising
receiving a message from a first wireless communication terminal not connected to the first wireless communication base station, the message including UL/DL coordination information including a set of the time-frequency resources that the first base station is prohibited from scheduling DL/UL transmission on;
scheduling UL/DL transmissions constrained by the UL/DL coordination information.

15. The method of claim 14 further comprising scheduling a second wireless communication terminal connected to the first wireless communication base station based on the DL/UL coordination information.

16. The method of claim 14 further comprising scheduling system broadcast information for transmission on a downlink based on the DL coordination information.
